(19) United States
(12) Patent Application Publication
(10) Pub. No.: US 2004/0017511 A1
(43) Pub. Date: Jan. 29, 2004

(54) Video information indexing support apparatus and method, and computer program

(76) Inventor: Takayuki Kunieda, Tokyo (JP)

Correspondence Address: DICKSTEIN SHAPIRO MORIN & OSHINSKY LLP, 2101 L STREET NW, WASHINGTON, DC, 20037-1526, US

(21) Appl. No.: 10/457,627

(22) Filed: Jun. 10, 2003

(30) Foreign Application Priority Data
Jun. 14, 2002 (JP) 2002-174479

(51) Int. Cl. H04N 7/12

(52) U.S. Cl. 348/461; 375/240.26

(57) ABSTRACT

A video information indexing support apparatus includes a video capture device configured to capture a video that a video recorder records, a video storage device configured to store the video captured by the video capture device, and an event recording device configured to record, as event information, information of an event occurring in relation to content of the video that the video recorder records.

### CROSS-REFERENCE TO RELATED APPLICATIONS

The present application claims priority and contains subject matter related to Japanese Patent Application No. 2002-174479 filed in the Japanese Patent Office on Jun. 14, 2002, and the entire contents of which are hereby incorporated by reference.

### FIELD OF THE INVENTION

The present invention relates to a video information indexing support apparatus and method for supporting indexing video information and a computer program .

### BACKGROUND OF THE INVENTION

When indexing video information of a video, it is necessary to add to the content of the video, information of events that occurred in relation to the content of the video. In order to add information of events to the content of the video, generally, an operator actually sees the whole portion of the video to gain an understanding of the content of the video, assesses changes in the scene and/or topic in the video, and determines information as to events that should be added to the content of the video. Video information of a video that has been thus indexed can be accessed for each scene, and further, can be retrieved using the information of events added to content of the video.

However, indexing video information takes a relatively long time and is complicated. In particular, capturing and editing a video and describing the content of the video take a great deal of time and effort.

### BRIEF SUMMARY OF THE INVENTION

The present invention has been created in view of the above-described and other problems and addresses the above-described and other problems.

Preferred embodiments of the present invention provide a novel video information indexing support apparatus and method that makes indexing video information easier.

According to a preferred embodiment of the present invention, a video information indexing support apparatus includes a video capture device configured to capture a video that a video recorder records, a video storage device configured to store the video captured by the video capture device, and an event recording device configured to record, as event information, information of an event occurring in relation to content of the video that the video recorder records.

Thus, the video information indexing support apparatus of the present invention not only captures a video but also records event information of an event occurring in relation to content of the video. Accordingly, generating an index for managing the video by the content of the video and describing the content of the video for accurately retrieving a scene and/or starting position for reproducing the video can be facilitated. Thereby, indexing video information can be made easier.

The above-described video information indexing support apparatus may further include a recording control device configured to control the video recorder according to the event information recorded by the event recording device.

Accordingly, in the video information indexing support apparatus of the present invention, because the recording control device can start and end video recording with the video recorder by the added event information, a dedicated person is unnecessary for the video recording with the video recorder.

Further, in the above-described video information indexing support apparatus, the event recording device may record, as the event information, information of an operation of an input device of a computer for switching a screen, which is a part of the content of the video that the video recorder records.

Accordingly, when video recording the scene of delivering a lecture or presentation using electronic presentation material, by recording, as event information, information of operations of a computer used in displaying the electronic presentation material on a projecting screen with a projector, indexing video information can be made easier.

Furthermore, in the above-described video information indexing support apparatus, the event recording device may record, as the event information, content of the event and a time the event occurs in chronological order.

Accordingly, the event information and content of the video can be associated with each other via time information, so that checking of the event information and the content of the video is not necessary.

Still further, the above-described video information indexing support apparatus may further include an index generation device configured to associate information of the video stored by the video storage device and the event information recorded by the event recording device with each other in chronological order.

Accordingly, a desired scene and/or starting position for reproducing the video can be accurately retrieved.

Still further, in the above-described video information indexing support apparatus, the index generation device may associate additional information relating to the content of the video with the event information.

Accordingly, the event information can be retrieved by content of the additional information, so that a desired scene and/or starting position for reproducing the video can be easily retrieved.

According to another preferred embodiment of the present invention, a method of supporting video information indexing is provided. The method includes capturing a video that a video recorder records; storing the captured video; and recording event information of an event occurring in relation to content of the video that the video recorder records.

The method may further include controlling the video recorder according to the recorded event information.

In the method, the event information recording step may record, as the event information, information of an operation of an input device of a computer for switching a screen which is a part of the content of the video that the video recorder records.

Further, the event information recording step may record, as the event information, content of the event and a time the event occurs in chronological order.

Furthermore, the method may further include associating information of the video stored in the video storing step and the event information recorded in the event information recording step with each other in chronological order.

Still further, in the method, the associating step may associate additional information relating to the content of the video with the event information.

### BRIEF DESCRIPTION OF THE DRAWINGS

A more complete appreciation of the present invention and many of attendant advantages thereof will be readily obtained as the same becomes better understood by reference to the following detailed description when considered in conjunction with accompanying drawings, wherein:

FIG. 1 is a block diagram of an exemplary hardware configuration of a video information indexing support system according to a preferred embodiment of the present invention;

FIG. 2 is a block diagram illustrating electrical connections of a PC used in the video information indexing support system of FIG. 1;

FIG. 3 is a functional block diagram of an exemplary video information indexing support system; and

FIG. 4A, FIG. 4B and FIG. 4C are diagrams illustrating an exemplary method of indexing video information using the video information indexing support system.

### DETAILED DESCRIPTION OF THE INVENTION

Referring now to the drawings, wherein like reference numerals designate identical or corresponding parts throughout the several views, preferred embodiments of the present are described.

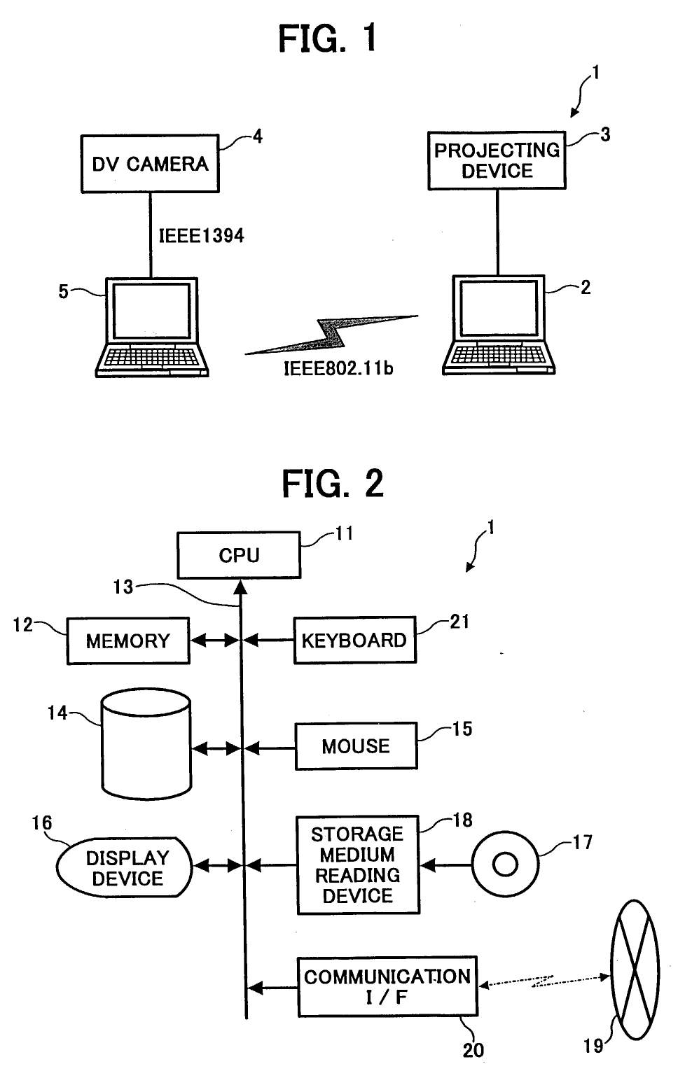

FIG. 1 is a block diagram illustrating an exemplary hardware configuration of a video information indexing support system according to a preferred embodiment of the present invention.

In this embodiment, description will be made using as an example recording of video states of the delivery of a lecture or presentation using electronic presentation material. When delivering a lecture or presentation using electronic presentation material, generally, a speaker stores the electronic presentation material in a personal computer (PC) connected with a projecting device such as a projector, and delivers the presentation while operating presentation software stored in the PC for projecting and displaying the electronic presentation material on a projecting screen with the projecting device.

As illustrated in FIG. 1, a video information indexing support system 1 includes a PC 2 for storing electronic presentation material for the presentation, a projecting device 3 such as a projector connected with the PC 2 to project and display the electronic presentation material on a projecting screen, a digital video (DV) camera 4 serving as a video recording device for video recording states of the presentation, and a PC 5 connected with the DV camera 4 by an interface such as, for example, IEEE1394 to control the DV camera 4. The PC 2 and the PC 5 are connected with each other by wireless connection such as IEEE802.11b. When wireless communication environment is not available, the PC 2 and the PC 5 may be connected with each other by peer-to-peer connection such as Ethernet.

FIG. 2 is a block diagram illustrating components and electrical connections within the PC 2 and the PC 5. As illustrated in FIG. 2, each of the PC 2 and the PC 5 includes a CPU 11 performing various calculations and controlling of respective parts of the PC 2 and the PC 5, a memory 12 including various ROMs and RAMs, and a bus 13 by which the CPU 11 and the memory 12 are connected.

A magnetic storage device 14 including, for example, a hard disk, a mouse 15 serving as an input device, a keyboard 21 serving as another input device, and a display device 16 such as a liquid crystal display (LCD), each of which are connected by the bus 13 via predetermined interfaces. Further, a storage medium reading device 18 for reading a storage medium 17 such as an optical disk, etc., and a communication interface 20 for communicating with a network 19 such as the Internet may be connected with the bus 13. For the storage medium 17, various types of media can be used, such as, but not limited to, an optical disk, for example, a CD and/or a DVD, an optical magnetic disk, a flexible disk, etc. For the storage medium reading device 18, an optical disk device, an optical magnetic device, etc. may be used according to the type of a storage medium used for the storage medium 17.

The PC 2 and the PC 5 respectively store in their magnetic storage devices 14 a video information indexing support program according to a preferred embodiment of the present invention. The video information indexing support program is installed into the magnetic storage device 14 by reading from the storage medium 17 with the storage medium reading device 18, or by downloading from the network 19 such as the Internet. The PC 2 and the PC 5 are put into operable states respectively by installing the video information indexing support program. That is, the CPU 11 operates according to the video information indexing support program, via functions of various modules that will be described later. The video information indexing support program may be a part of specific application software or a program that can be operated via an operation system (OS). The PC 2 also stores in the magnetic storage device 14 presentation software for projecting and displaying electronic presentation material stored in the PC 2.

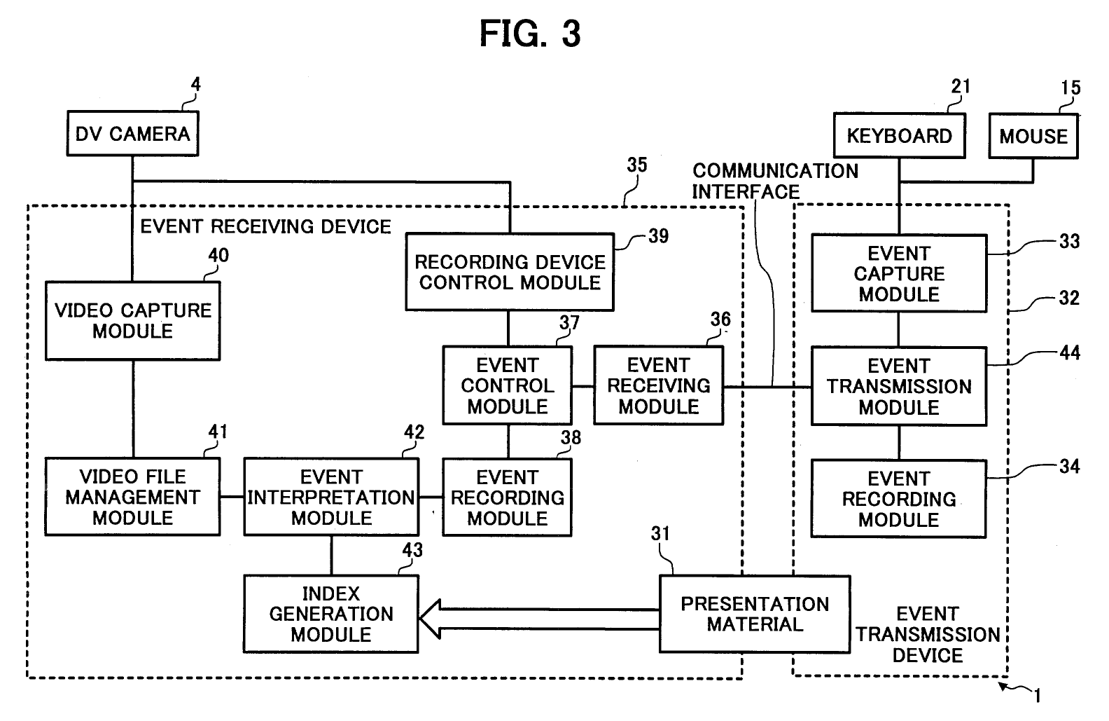

FIG. 3 is a functional block diagram of the video information indexing support system 1 that is realized by the video information indexing support program, etc.

The PC 2 stores electronic presentation material 31 in the magnetic storage device 14, and a speaker delivers presentation while projecting and displaying the electronic presentation material 31 on the projecting screen with the projecting device 3 by operating the presentation software stored in the magnetic storage device 14. The PC 2 functions as an event generation device generating events described later.

Generally, the procedure for operating the PC 2 for delivering presentation is as follows;

1. Activate the PC 2

2. Activate the presentation software

3. Start projecting and displaying the presentation material 31

4. Turn pages of the presentation material 31 using the keyboard 21 or the mouse 15

5. End projecting and displaying the presentation material 31

6. Terminate the presentation software

7. Terminate the PC 2

The PC 2 also functions as an event transmission device 32 according to the video information indexing support program, and accurately records operations of the PC 2 functioning as the event generation device, i.e., events occurring in relation to content of a video the DV camera 4 records while the presentation is delivered. Thereby, efficiently indexing the video the DV camera 4 records is made easier.

When the presentation is delivered in the above-described procedure, events that occur in relation to content of the video the DV camera 4 records and that can be captured on the PC 2 are as follows;

1. Activation and termination of the presentation software

2. Operations of the keyboard 21, i.e., operations of various keys of the keyboard 21

3. Operations of the mouse 15, e.g., dragging and clicking

That is the projecting screen on which the presentation material 31 is projected and displayed constitutes at least a part of the content of the video that the DV camera 4 records, and operations of the PC 2 for switching the screen to a page of the presentation material 31, projected and displayed on the projecting screens are taken as events. Further, it is necessary to accurately record the time the event occurs and the kind of the event, as event information relating to the event.

Accordingly, the event transmission device 32 is configured to obtain the type and the time of occurrence of each event as event information by an event capture module 33. An event recording module 34 records logging of the event information, and an event transmission module 44 transmits the event information, via a communication interface, to an event receiving device 35, which is realized according to the video information indexing support program by the PC 5 as a video information indexing support apparatus of the present invention.

The event information transmitted by the event transmission device 32 is received at the event receiving device 35 by an event receiving module 36, which interfaces with an event control module 37. The event control module 37 delivers the received event information to an event recording module 38 and a recording device control module 39. The event recording module 38 performs an event recording process of the present invention, and records the event information received from the event transmission device 32, in chronological order.

The recording device control module 39 performs a recording control process of the present invention, and controls the DV camera 4 according to the event information received from the event control module 37. A video capture module 40 performs a video capture process of the present invention, and captures a video recorded by the DV camera 4. A video file management module 41 performs a video storing process of the present invention, and stores the video recorded by the DV camera 4 in the magnetic storage device 14 of the PC 5 as a video file and manages the video file. The event recording module 38 records not only the event information received from the event transmission device 32 but also event information relating to control of the DV camera 4.

An event interpretation module 42 interprets content of the recorded event information, and an index generation module 43 indexes the video recorded by the DV camera 4 based upon the presentation material 31, the video file and the event information stored in the magnetic storage device 14 of the PC 5. Here, the presentation material 31 stored in the PC 2 is transferred to the PC 5 to be stored in the magnetic storage device 14, for example, when recording with the DV camera 4 has been terminated by control of the recording device control module 39.

Now, transmission of event information between the event transmission device 32 and the event receiving device 35 is specifically described.

When an event that the presentation software is activated occurs at the PC 2 functioning as the event generation device and the event transmission device 32, the recording device control module 39 of the PC 5 functioning as the event receiving device 35 starts video recording with the DV camera 4. Further, the event recording module 38 records event information of this event received from the event transmission device 32.

While presentation using the presentation material 31 is proceeding, an event that the keyboard 21 is operated occurs, and the event recording module 38 records event information of such an event received from the event transmission device 32.

When an event that the presentation software is terminated has occurred at the PC 2, the recording device control module 39 terminates video recording with the DV camera 4. Further, the event recording module 38 records event information of this event.

Thus, event information of an event occurring in relation to a video recorded by the DV camera 4 can be recorded and managed, together with the video recorded by the DV camera 4, by the event receiving device 35.

The recorded event information is merged by the index generation module 43 functioning as the index generation device with the video file and the presentation material 31 in the following procedure, to be managed by a content description language, such as MPEG-7, etc., as a video index.

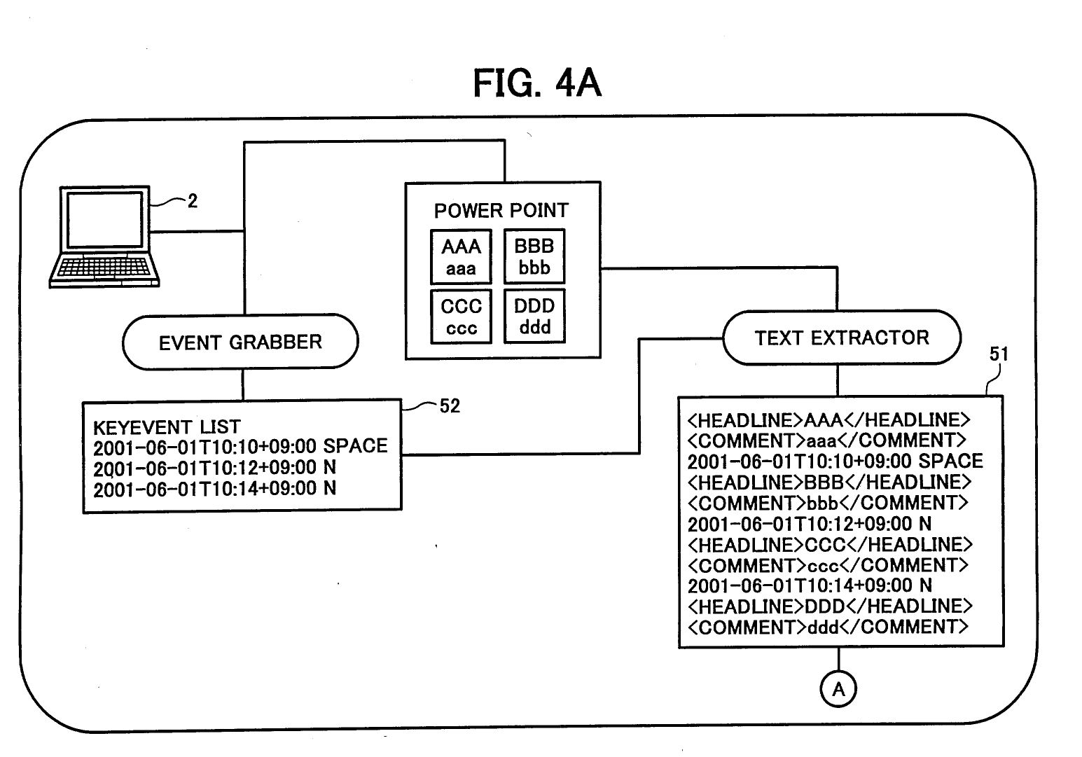

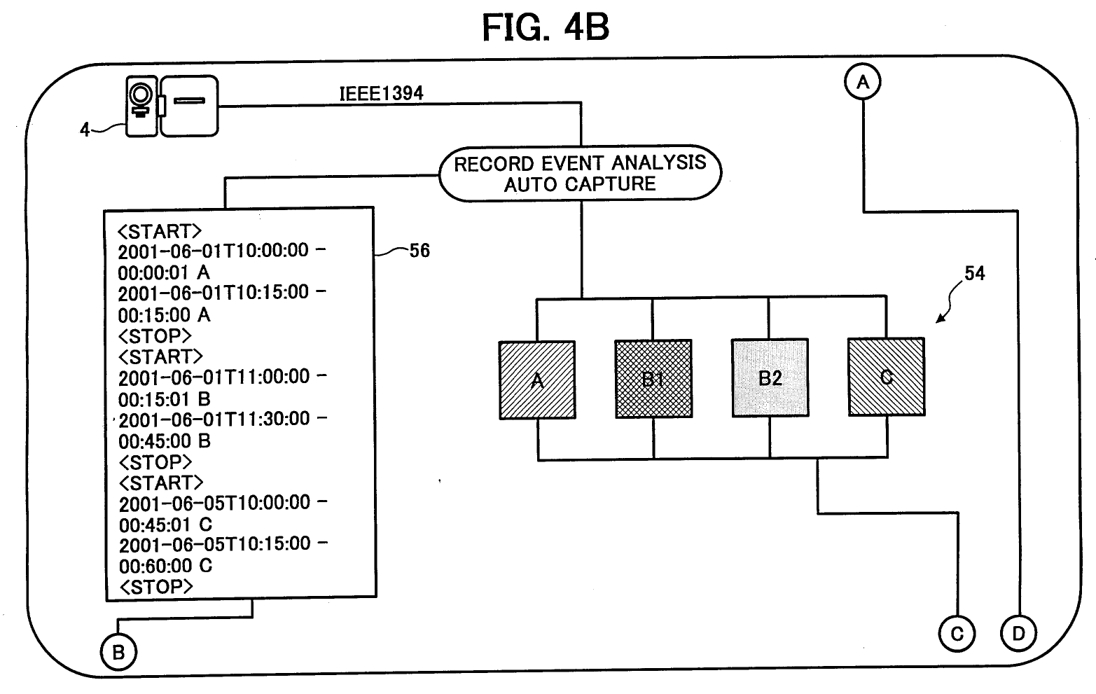

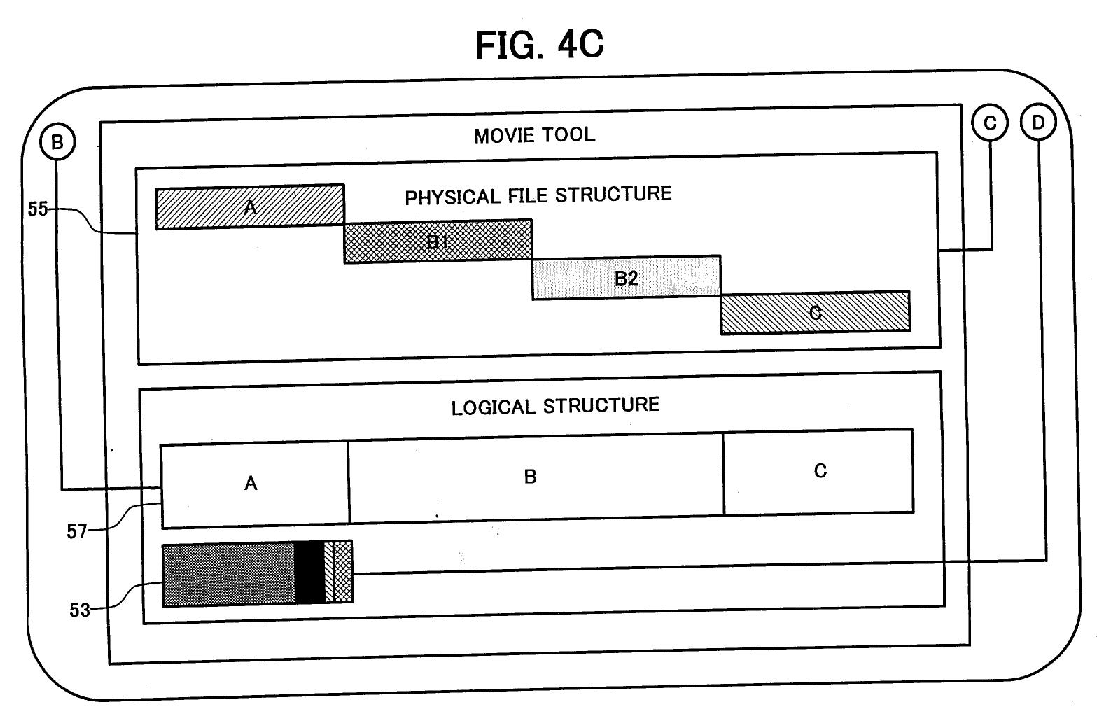

First, content of presentation, which is associated with event information, is added, as additional information, to the event information. For example, if events by operations of the keys of the keyboard 21 in the order of “N (next page), N, N, P (previous page), N, N” occur, it is predictable that the page of the presentation material 31 is turned in the order of “1, 2, 3, 2, 3, 4”. Accordingly, as illustrated in FIG. 4A, a character information 51 is extracted from respective pages of the presentation material 31 corresponding to the above-described events, and the character information 51 is added to an event information 52 as event information of the above-described events by operations of the keyboard 21. The character information 51 may be, for example, character strings included in the respective pages of the presentation material 31 corresponding to the above-described events. Thus, a character string representing content of the presentation material 31 being displayed at the time each event occurs can be added to event information of the event to be managed as index information 53 (see FIG. 4C).

The video recorded by the DV camera 4 is stored in units of a recording cut as a physical file 54 in such formats as AVI (Audio Video Interleaved), MPEG-1, 2, 4, etc. (see FIG. 4B). Further, a group of videos having a meaning is treated as a video file group 55 (see FIG. 4C).

The video file group 55 that is managed as one group having a meaning and the index information 53 are associated with each other by time codes recorded in the videos (when time codes are not recorded in the videos, by conversion of the number of frames per one second)(see FIG. 4C), so that each event and the starting position for reproducing the videos can be specified. Thus, recording video information and event information to be associated with each other in chronological order is enabled. An event information 56 relating to the start and the termination of recording with the DV camera 4 is also associated, as a index information (start and stop video recording) 57, with the video file group 55 and the index information (event time codes) 53.

Thus, by recording and managing the video file group 55 as video information, and the index information (event time codes) 53 and the index information (start and stop video recording) 57 managing content of the video file group 55, to be associated with each other, recorded video can be retrieved by a change in the page of the presentation material 31 and by content of the presentation material 31, and thereby extracting and browsing only related information is enabled.

The mechanism and processes set forth in the present description may be implemented as a computer program programmed according to the teachings in the present specification, as will be appreciated to those skilled in the relevant arts. Appropriate software coding can be readily prepared by skilled programmers based upon the teachings of the present disclosure, as will be also apparent to those skilled in the relevant arts.

While an exemplary embodiment is described in terms of a software program, other alternatives such as, but not limited to, are hardware, firmware, Application Specific Integrated Circuits (ASICs) and Field Programmable Gate Arrays (FPGAs) in any combination of the above devices.

Numerous additional modifications and variations of the present invention are possible in light of the above teachings. It is therefore to be understood that within the scope of the appended claims, the present invention can be practiced otherwise than as specifically described herein and the scope of the invention is limited only by the claims appended hereto.

While the invention has been described and illustrated with reference to specific exemplary embodiments, it should be understood that many modifications and substitutions can be made without departing from the spirit and scope of the invention. Accordingly, the invention is not to be considered as limited by the foregoing description but is only limited by the scope of the appended claims.

What is claimed as new and desired to be protected by letters patent of the united states is:

1. A video information indexing support apparatus, comprising:
a video capture device configured to capture a video that a video recorder records;
a video storage device configured to store the video captured by the video capture device; and
an event recording device configured to record, as event information, information of an event occurring in relation to content of the video that the video recorder records.

2. The video information indexing support apparatus according to claim 1, further comprising:
a recording control device configured to control the video recorder in response to the event information recorded by the event recording device.

3. The video information indexing support apparatus according to claim 1, wherein the event recording device records, as event information, information of an operation of an input device of a computer for switching a screen, which is a part of the content of the video that the video recorder records.

4. The video information indexing support apparatus according to claim 1, wherein the event recording device records, as event information, content of the event and a time the event occurs in chronological order.

5. The video information indexing support apparatus according to claim 1, further comprising: an index generation device configured to associate information of the video stored by the video storage device; and the event information recorded by the event recording device with each other in chronological order.

6. The video information indexing support apparatus according to claim 5, wherein the index generation device associates additional information relating to the content of the video with the event information.

7. A method of supporting video information indexing, comprising:
capturing a video that a video recorder records;
storing the captured video; and
recording event information of an event occurring in relation to content of the video that the video recorder records.

8. The method according to claim 7, further comprising:
controlling the video recorder in response to the recorded event information.

9. The method according to claim 7, wherein the event information recording act records, as the event information, information of an operation of an input device of a computer for switching a screen which is a part of the content of the video that the video recorder records.

10. The method according to claim 7, wherein the event information recording act records, as the event information, content of the event and a time the event occurs in chronological order.

11. The method according to claim 7, further comprising:
associating information of the video stored in the video storing act and the event information recorded in the event information recording act with each other in chronological order.

12. The video information indexing supporting method according to claim 11, wherein the associating act associates additional information relating to the content of the video with the event information

13. A computer program directly loadable into a computer, comprising computer program instructions which when executed by the computer perform a video information indexing support operation comprising:
capturing a video that a video recorder records;
storing the captured video; and
recording event information of an event occurring in relation to content of the video that the video recorder records.

14. The computer program according to claim 13, wherein the video information indexing support operation further comprises controlling the video recorder in response to the recorded event information.

15. The computer program according to claim 13, wherein the event information recording act records, as the event information, information of an operation of an input device of a computer for switching a screen which is a part of the content of the video that the video recorder records.

16. The computer program according to claim 13, wherein the event information recording act records, as the event information, content of the event and a time the event occurs in chronological order.

17. The computer program according to claim 13, wherein the video information indexing support operation further comprises associating information of the video stored in the video storing act and the event information recorded in the event information recording act with each other in chronological order.

18. The computer program according to claim 17, wherein the associating act associates additional information relating to the content of the video with the event information.

19. A computer readable medium storing computer program instructions which when executed by a computer perform a video information indexing support operation comprising:
capturing a video that a video recorder records;
storing the captured video; and
recording event information of an event occurring in relation to content of the video that the video recorder records.

20. The computer readable medium according to claim 19, wherein the video information indexing support operation further comprises controlling the video recorder in response to the recorded event information.

21. The computer readable medium according to claim 19, wherein the event information recording act records, as the event information, information of an operation of an input device of a computer for switching a screen which is a part of the content of the video that the video recorder records.

22. The computer readable medium according to claim 19, wherein the event information recording act records, as the event information, content of the event and a time the event occurs in chronological order.

23. The computer readable medium according to claim 19, wherein the video information indexing support operation further comprises associating information of the video stored in the video storing act and the event information recorded in the event information recording act with each other in chronological order.

24. The computer readable medium according to claim 23, wherein the associating act associates additional information relating to the content of the video with the event information.

25. A video information indexing system, comprising:
a presentation apparatus configured to project and display presentation material on a projecting screen, and to generate an event in relation to content of a screen of the presentation material, projected and displayed on the projecting screen, and transmit, as event information, information of the event;
a video recorder recording at least the presentation material as projected and displayed by the presentation apparatus on the projecting screen; and
a video information indexing support apparatus connected with the video recorder and including,
a video capture device configured to capture a video that the video recorder records,
a video storage device configured to store the video captured by the video capture device, and
an event recording device configured to record the event information received from the presentation apparatus.

26. The video information indexing system according to claim 25, wherein the video information indexing support apparatus further includes a recording control device configured to control the video recorder in response to the event information recorded by the event recording device.

27. The video information indexing system according to claim 25, wherein the event recording device of the video information indexing support apparatus records, as the event information, content of the event and a time the event occurs in chronological order.

28. The video information indexing system according to claim 25, wherein the video information indexing support apparatus further includes an index generation device configured to associate information of the video stored by the video storage device and the event information recorded by the event recording device with each other in chronological order.

29. The video information indexing system according to claim 28, wherein the index generation device associates additional information relating to the content of the video with the event information.

30. A method of indexing video information, comprising:
projecting and displaying presentation material on a projecting screen by a presentation apparatus;
generating an event in relation to content of a screen of the presentation material, projected and displayed on the projecting screen;
recording, as event information, information of the event;
recording by a video recorder at least the presentation material as projected and displayed by the presentation apparatus on the projecting screen;
capturing a video recorded in the video recording act; and
storing the captured video.

31. The video information indexing method according to claim 30, further comprising:
controlling the video recorder in response to the event information recorded in the event information recording act.

32. The video information indexing method according to claim 30, wherein the event information recording act records, as the event information, content of the event and a time the event occurs in chronological order.

33. The video information indexing method according to claim 30, further comprising:
associating information of the video stored in the video storing act and the event information recorded in the event information recording act with each other in chronological order.

34. The video information indexing method according to claim 33, wherein the associating act associates additional information relating to the content of the video with the event information.
